(19) United States
(12) Patent Application Publication
(10) Pub. No.: US 2012/0107512 A1
(43) Pub. Date: May 3, 2012

(54) BINDER FOR RBSC ASSEMBLY AND METHOD OF BINDING RBSC ASSEMBLY USING THE SAME

(75) Inventors: Sung-sic HWANG, Seoul (KR); Soo-hwan An, Pyeongtaek-si (KR); Seok-ho Jang, Icheon-si (KR); Hyung-woo Jun, Osan-si (KR); Ho-chan Lee, Yongin-si (KR); Kwang-il Ju, Goyang-si (KR)

(73) Assignee: SKC Solmics co.,Ltd, Pyeontaek (KR)

(21) Appl. No.: 13/336,041

(22) Filed: Dec. 23, 2011

(30) Foreign Application Priority Data
Aug. 19, 2009 (KR) 10-2009-0076587

(51) Int. Cl. B05D 7/24; B05D 3/02; C09D 1/00

(52) U.S. Cl. 427/397.7; 106/436; 106/457; 106/466; 106/480; 106/482

(57) ABSTRACT

The invention relates to a binder for binding RBSC (reaction-bonded silicon carbide), which is used to prepare RBSC assembly, wherein it includes a sintered body obtained by sintering a mixed powder of at least one substance selected from the group having Al, Ti, Fe, Mg, Cu and Ge, and silicon, or a powder obtained by milling the sintered body; and with regard to the mixing ratio of the mixed powder, the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram, and a method of binding RBSC using the same.

### FIELD OF THE INVENTION

The present invention relates to a binder for RBSC assembly and a method of binding RBSC assembly using the same and more particularly, to a binder for binding RBSC (reaction-bonded silicon carbide) wherein it makes it easy, by virtue of its stability at high temperature, to manufacture RBSC assembly which is used in various applications, and also makes it possible to bond single parts after they have been impregnated with silicon, without need of being bonded to produce an assembly, e.g., whole jig, prior to silicon impregnation process, so that impregnation tub can accommodate more materials and thus increase productivity and further in case that a defect occurs during processes subsequent to impregnation, it can be handled in a single part unit thereby improving manufacturing productivity, and a method of binding RBSC using the same.

### BACKGROUND OF THE INVENTION

Since reaction-bonded silicon carbide assembly has good thermal conductivity, corrosion resistance and chemical resistance, and low thermal expansion rate, compared to existing silicon or quartz materials that have been used in LP-CVD process, it is less likely to get damage even for a long-term use and thus draws attention as a material to be applicable to high temperature zone.

In particular, silicon carbide assembly with high purity (especially, jigs) is stable in high temperature conditions of at least 1,200° C. and thus, it largely contributes enhancement of quality and efficiency in semiconductor diffusion process, and upper pressure CVD and LP-CVD process. Specific examples may include wafer boats for semiconductor process, particularly, boats for diffusion process.

The reaction-bonded silicon carbide assembly has been manufactured commonly by reactive sintering methods and the sintered silicon carbide prepared thereby is called RBSC (reaction-bonded silicon carbide). There is disclosed a conventional method of manufacturing a sintered silicon carbide by a reactive sintering method in Korean Patent Laid-Open Publication No. 10-2004-111393, and the sintered silicon carbide prepared thereby always has a constant degree of residual Si that has been uncarbonized so that it can be also designated as Si—SiC.

With regard to a method of manufacturing a sintered silicon carbide assembly, an assembly (wafer boat) as shown in the figures of Korean Patent Laid-Open Publication No. 10-2004-111393 is manufactured commonly by carrying out the procedures of temporarily sintering single bodies (parts) constituting the whole assembly (jig) at 1500 to 2000° C. respectively to prepare temporarily-sintered single bodies; molding them in a desired shape; binding the molded single bodies according to the shape of the whole assembly (jig); temporarily sintering again the resultant body at 1500 to 2000° C. to prepare a molded, temporarily-sintered body; immersing it into a melted silicon of 1450 to 1700° C. so that the melted silicon can penetrate into the pores of the temporarily-sintered body and react with free carbon in the temporarily-sintered body to produce silicon carbide, by which the pores are filled (impregnation process) with silicon carbide and unreacted silicon; and optionally coating the surface of the sintered body with Si and heating it at 1450-1700° C. to form a SiC-rich layer on the surface.

However, in case that the wafer boat is manufactured by the above procedures in actual manufacturing process, the precision of assembly (jig) is deteriorated after immersion in the melted silicon so that it requires further processing procedures subsequent to the above impregnation process and such further processing subsequent to the impregnation process increases the intensity of the sintered body, thereby causing a damage or breakdown issue. When defect occurs in this step, the whole body of the assembly (jig) is to be discarded. Furthermore, since the molded, temporarily-sintered body is subject to impregnation process, it requires a large impregnation tub for immersion, of which the efficiency is therefore not very satisfactory. Moreover, since heating temperature is too high during the heating process for the formation of a SiC-rich layer, it causes the elution of Si in the sintered body.

Therefore, there is a great need of developing a binder which is able to solve the above mentioned problems and thus manufacture an assembly (jig) having a complicated shape with high productivity and reduced defect rates, without causing Si elution issue, and a binding method using the same.

### SUMMARY OF THE INVENTION

Accordingly, it is an object of the invention to provide a binder for binding RBSC (reaction-bonded silicon carbide) wherein it makes it easy, by virtue of its stability at high temperature, to manufacture RBSC assembly which is used in various applications, and also makes it possible to bond single parts after they have been impregnated with silicon, without need of being bonded to produce an assembly, e.g., whole jig, prior to silicon impregnation process, so that impregnation tub can accommodate more materials and thus increase productivity and further in case that defect occurs during processes subsequent to impregnation, it can be handled in a single part unit thereby improving manufacturing productivity, and a method of binding RBSC using the same.

It is another object of the invention to provide a method of preparing a binder for binding a sintered silicon carbide, capable of achieving the aforementioned objects as well as solving Si elution and binder elution issues.

In order to achieve the objects, the present invention provides a binder for binding RBSC (reaction-bonded silicon carbide), which is used to prepare RBSC assembly,

wherein it comprises a sintered body obtained by sintering a mixed powder of at least one substance selected from the group consisting of Al, Ti, Fe, Mg, Cu and Ge, and silicon, or a powder obtained by milling the sintered body; and

with regard to the mixing ratio of the mixed powder, the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram.

The present invention further provides a method of binding RBSC (reaction-bonded silicon carbide) wherein it comprises temporarily bonding RBSC assembly components which will constitute RBSC assembly; and

applying the binder for binding RBSC as defined in the above to the temporarily-bonding surface of the RBSC assembly components and impregnating the binder into the bonding surface by thermal treatment at 1300 to 1400° C. to complete the assembly.

Finally, the present invention provides a method of manufacturing a binder for binding reaction-bonded silicon carbide, wherein it comprises

preparing a mixed powder at least one substance selected from the group consisting of Al, Ti, Fe, Mg, Cu and Ge, and silicon in a mixing ratio in which the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram; and

sintering the mixed powder to prepare a sintered binder, or milling the sintered binder to prepare a sintered binder powder.

According to the binder for binding RBSC (reaction-bonded silicon carbide) and the binding method using the same of the present invention, it makes it easy, by virtue of its stability at high temperature, to manufacture RBSC assembly which is used in various applications, and also makes it possible to bond single parts using the binder after they have been impregnated with silicon, without need of being bonded to produce an assembly, e.g., whole jig, prior to silicon impregnation process, so that impregnation tub can accommodate more materials and thus increase productivity and further in case that defect occurs during processes subsequent to impregnation, it can be handled in a single part unit thereby improving manufacturing productivity.

### BRIEF DESCRIPTION OF THE DRAWINGS

FIG. 1 shows a two component (binary system) phase diagram of Al—Si and their possible composition ranges.

FIG. 2 shows a two component (binary system) phase diagram of Ti—Si and their possible composition ranges.

FIG. 3 shows a two component (binary system) phase diagram of Fe—Si and their possible composition ranges.

FIG. 4 shows a two component (binary system) phase diagram of Mg—Si and their possible composition ranges.

FIG. 5 shows a two component (binary system) phase diagram of Cu—Si and their possible composition ranges.

FIG. 6 shows a two component (binary system) phase diagram of Ge—Si and their possible composition ranges.

FIG. 7 is a schematic diagram illustrating step-by-step bonding procedures regarding how the binder for binding reaction-bonded silicon carbide of the present invention is applied

FIG. 8 is a microscope picture showing the fine structure of a bonding portion of the assembly manufactured by the method of binding reaction-bonded silicon carbide according to the present invention.

### DETAILED DESCRIPTION OF THE INVENTION

Hereafter the invention is further described in detail with reference to the drawings.

The present invention addresses a binder for binding RBSC (reaction-bonded silicon carbide) which is used to prepare RBSC assembly, wherein it comprises a sintered body obtained by sintering a mixed powder of at least one substance selected from the group consisting of Al, Ti, Fe, Mg, Cu and Ge, and silicon, or a powder obtained by milling the sintered body; and with regard to the mixing ratio of the mixed powder, the maximum amount of silicon is an amount rendering the complete melting temperature of phase in phase diagram of the mixed powder to be at most 1400 ° C., and the minimum amount of silicon is a larger value of either 50 at % or the minimum amount of silicon in silicon+liquid phase zone of the phase diagram.

The reaction-bonded silicon carbide has a structure in which silicon is melted, impregnated into a porous network structure body comprising silicon carbide, a portion of the silicon is carbonized again to be converted to silicon carbide and the remainder remains as silicon, and it is usually used in high-temperature operation conditions.

Therefore, a good binder for binding those reaction-bonded silicon carbides is required to make bonding reaction possible in such a temperature condition that remaining silicon in RBSC is not eluted, to maintain its stability at high temperature, to be readily melted, impregnated into RBSC and to have a thermal expansion coefficient similar to RBSC.

The inventors have mixed silicon with certain substance and chosen ones which were able to react with silicon, have the same crystal structure as silicon, and have similar atom radius, electronegativity and valence electrons and among them, further selected substances capable of maintaining silicon+liquid phase in silicon-rich zone of phase diagram and being stably synthesized with silicon.

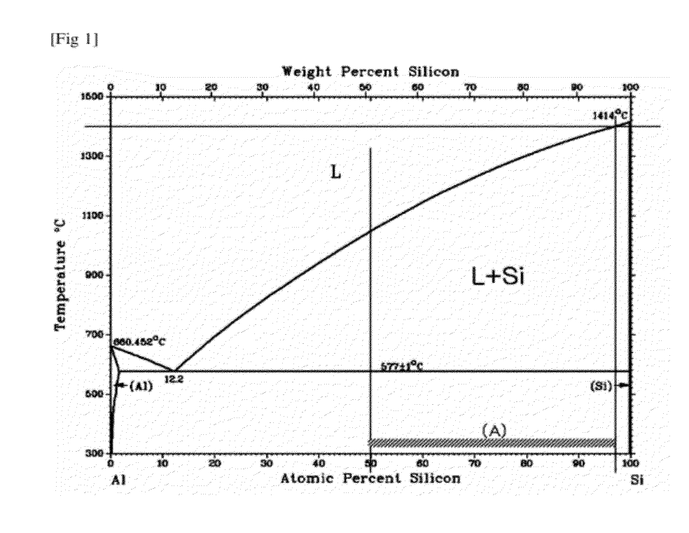

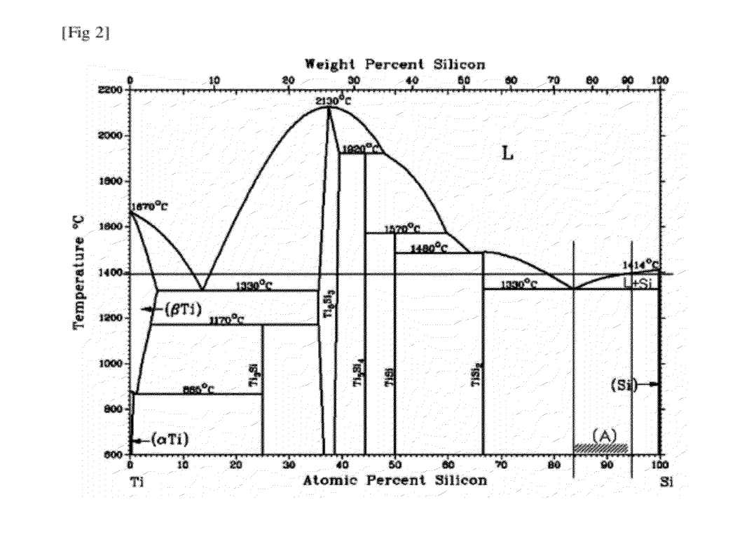

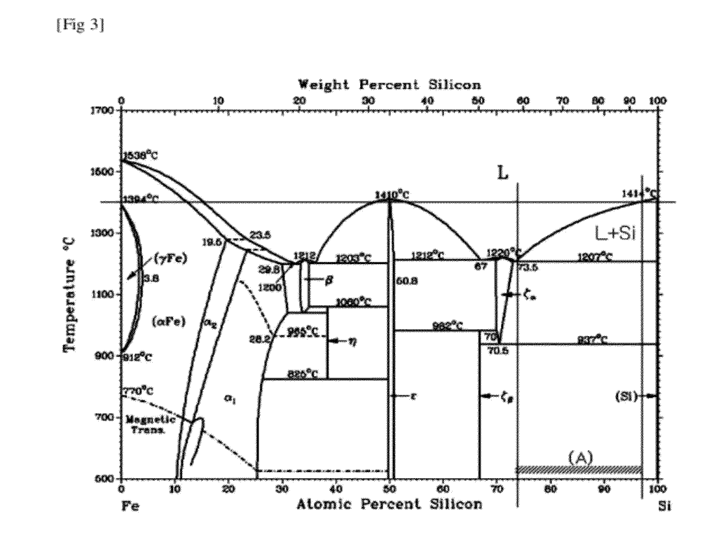

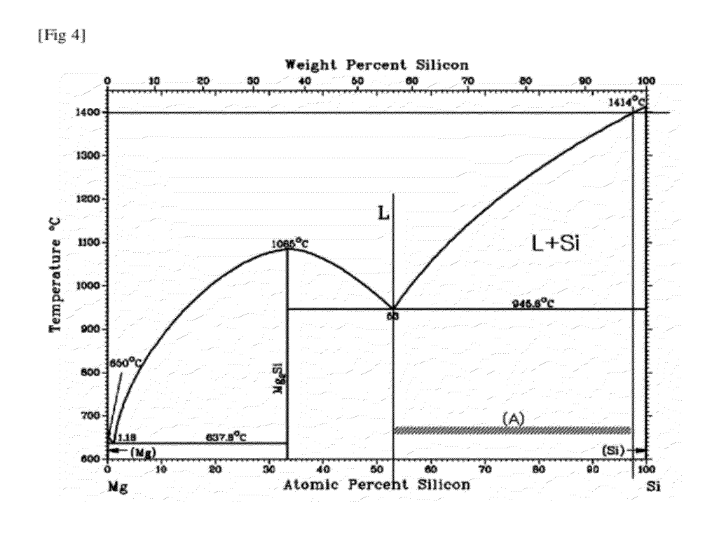

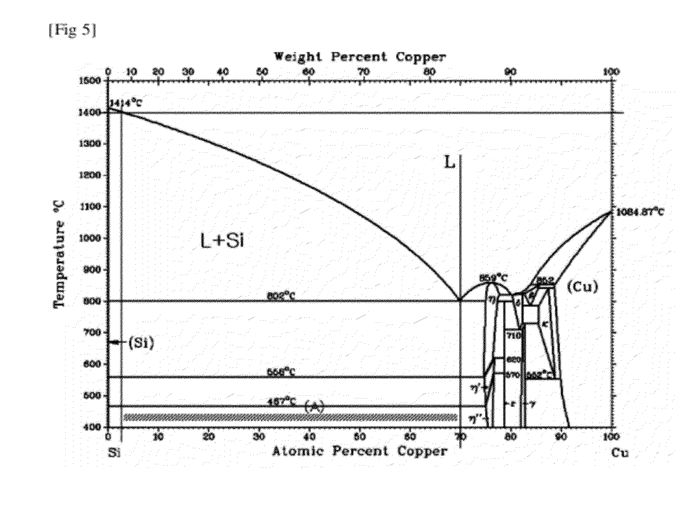

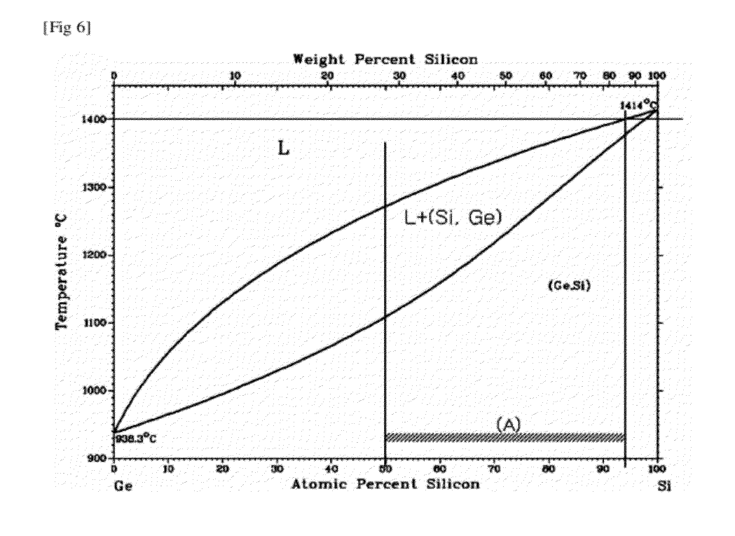

The substances satisfying all of the conditions may include Al, Ti, Fe, Mg, Cu, and Ge. Their binary phase diagrams with silicon are as shown in FIG. 1 to FIG. 6.

Al—Si has silicon+liquid phase in the zone where the content rate of Si is 12 to 100 at %; Ti—Si has silicon+liquid phase in the zone where the content rate of Si is 84 to 100 at %; Fe—Si has silicon+liquid phase in the zone where the content rate of Si is 73 to 100 at %; Mg—Si has silicon+liquid phase in the zone where the content rate of Si is 53 to 100 at %; Cu—Si has silicon+liquid phase in the zone where the content rate of Si is 31 to 100 at %; and Ge—Si has silicon+liquid phase in the zone where the content rate of Si is 0 to 100 at % (in case the content rate of Si is literally 0 or 100 at %, that is a pure substance, it is impossible to have silicon+liquid phase; for convenience they are expressed in that way, but it is noted that those points are exclusive.).

With regard to the mixing ratio of the mixed powder, the maximum amount of silicon is limited to be an amount rendering the complete melting temperature of phase in phase diagram of the mixed powder to be at most 1400° C. in order to satisfy the above conditions in the zone having silicon+liquid phase. In case of exceeding the above amount, silicon may elute from RBSC; its upper limit is thus defined. Next, the minimum amount of silicon is defined by a larger value of either 50 at % or the minimum amount of silicon in silicon+liquid phase zone of the phase diagram. This is because only when the amount of silicon exceeds at least half of the total amount, the binder can be readily melted, impregnated into RBSC and have thermal expansion coefficient similar to RBSC. Further, in order to maintain stable phase with silicon, it requires silicon in an amount more than the minimum amount of silicon in silicon+liquid phase zone.

In each phase diagram, the range of the amounts satisfying those conditions is designated by zone (A).

Therefore, in case of mixing in binary system, mixing is carried out within the above ranges and even in case of ternary or higher system, mixing can be carried out according to the same principle.

The mixing of the silicon and other elements may be conducted preferably by mixing silicon powder with the powder of other elements and more preferably, they may be mixed using a ball milling. For example, two kinds of powders having an average particle size of around 50 μm may be mixed using a ball milling for 6 hours.

Preferably, with regard to the mixing ratio, in order to secure stability at high temperature so that RBSC assembly which has been bonded can be utilized at high temperature, i) in case that aluminum powder is mixed with silicon powder, it is preferable to mix 10 to 50 at % of the aluminum powder and 50 to 90 at % of the silicon powder in that the melting temperature of the binder is kept at a certain temperature or above; ii) in case that titanium powder is mixed with silicon powder, it is preferable to mix 14 to 18 at % of the titanium powder and 82 to 86 at % of the silicon powder in that the melting temperature of the binder is kept at a certain temperature or above; iii) in case that iron powder is mixed with silicon powder, it is preferable to mix 11 to 19 at % of the iron powder and 81 to 89 at % of the silicon powder in that the melting temperature of the binder is kept at a certain temperature or above; iv) in case that magnesium powder is mixed with silicon powder, it is preferable to mix 8 to 28 at % of the magnesium powder and 72 to 92 at % of the silicon powder in that the melting temperature of the binder is kept at a certain temperature or above; v) in case that copper powder is mixed with silicon powder, it is preferable to mix 13 to 36 at % of the copper powder and 64 to 87 at % of the silicon powder in that the melting temperature of the binder is kept at a certain temperature or above; and vi) in case that germanium powder is mixed with silicon powder, it is preferable to mix 5 to 35 at % of the germanium powder and 65 to 95 at % of the silicon powder in that the melting temperature of the binder is kept at a certain temperature or above.

The mixed powder having those mixing ratio is subject to sintering process to form a sintered body, which is then used as a binder, or the sintered body obtained through the sintering process is further milled and then used as a binder in the form of powder. It is to be understood that the mixed powder may be optionally subject to press molding prior to the sintering process.

Conventional sintering process may be applied to the above sintering process, and preferably, in case that a substance to be mixed has a lower melting point than silicon, it is advantageous that a first sintering is carried out at a temperature slightly higher than the melting temperature of the substance to be mixed, so as to melt the mixture substance and diffuse the melted mixture substance around the silicon powder, and after the mixture substance has been readily diffused into silicon, a second sintering is carried out at a higher temperature. Al, Mg, Cu, Ge, etc. fall in those mixture substances, and in the other cases, temperature condition for sintering may be determined within such a range that the mixture substances that have been melted does not vanish by evaporation.

It is preferred that in the case of Al+Si, the first sintering is carried out at 800° C.±100° C. and the second sintering is carried out 1000° C.±50° C.; in the case of Ti+Si, the first sintering is carried out at 1000° C.±50 ° C. and the second sintering is carried out 1250° C.±50° C.; in the case of Fe+Si, the first sintering is carried out at 1100° C.±50° C. and the second sintering is carried out 1210° C.±50° C.; in the case of Mg+Si, the first sintering is carried out at 800° C.±100° C. and the second sintering is carried out 1050° C.±50° C.; in the case of Cu+Si, the first sintering is carried out at 1100° C.±50° C. and the second sintering is carried out 1200° C.±50° C.; and in the case of Ge+Si, since they form a full solid solution, they can be sintered either by a two-step sintering process as described above or preferably, a single sintering process at 1150° C.±50° C.

The sintering time may be preferably 30 min to 1 hour for the first sintering and 2 to 4 hours for the second sintering or single sintering, for even synthesis.

The sintered body obtained through the sintering or the sintered powder obtained by milling the sintered body is used as a binder for RBSC. For this, the present invention provides a method of binding RBSC (reaction-bonded silicon carbide) using the sintered binder, wherein it comprises either temporarily bonding RBSC assembly components which will constitute RBSC assembly; and applying the binder for binding RBSC to the temporarily-bonding surface of the RBSC assembly components and impregnating the binder into the bonding surface by thermal treatment at 1300 to 1400° C. to complete the assembly; or adding a solvent to the binder for binding RBSC in the form of powder to prepare a mixture body in the form of slurry; and binding RBSC assembly components, which will constitute RBSC assembly, with the mixture body in the form of slurry and impregnating the binder into the bonding surface by thermal treatment at 1300 to 1400° C. to complete the assembly.

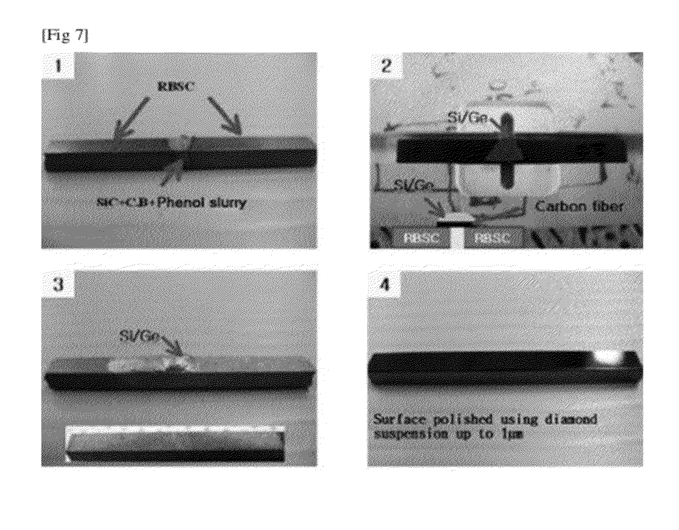

The temporary bonding may include a fixture-based bonding where assembly components are secured at assembly location by fixture, or a conventional binder-based bonding and for example, it may be carried out by applying a conventional slurry for bonding to perform a temporary bonding and then applying the inventive binder in the form of bulk or powder to the boundary surface at which the temporary bonding has been done and impregnating the binder into the bonding surface by thermal treatment at 1300 to 1400° C. to complete the assembly, as shown in FIG. 7. In other words, in the temporary bonding step, the assembly components may be bonded with a bonding slurry and then, on the bonding surface which has been bonded with the bonding slurry, the inventive binder for binding reaction-bonded silicon carbide may be simply applied, or after a carbon fiber or carbon fiber felt is attached onto the bonding surface so that a binder, which has been melted, can travel along with the carbon fiber, the inventive binder for binding reaction-bonded silicon carbide may be applied onto the thus obtained bonding surface with the carbon fiber attached thereon and then impregnated into the bonding surface by thermal treatment at 1300 to 1400° C. to complete the assembly.

The bonding slurry may be conventional bonding slurries that have been used for the manufacture of RBSC assembly and for example, it may include a mixture where silicon carbide powder is mixed with solvents such as phenol, or a mixture further comprising a carbon source substance including carbon black in addition to the former mixture.

Furthermore, the binder itself may be prepared in the form of slurry as described in the above and it may be applied to the bonding surface of the assembly components and then immediately impregnated. To the binder for binding reaction-bonded silicon carbide in the form of powder may be added various solvents including a solvent capable of becoming carbon sources such as phenol to prepare a mixture body in the form of slurry and then, the mixture body in the form of slurry may be applied to the bonding surface of the RBSC (reaction-bonded silicon carbide) assembly components (which will eventually constitute RBSC assembly), which may be then bonded with the mixture body in the form of slurry and subject to thermal treatment at 1300 to 1400° C. to impregnate the binder into the bonding surface, thereby completing the assembly.

The thermal treatment temperature may be preferably between 1350 and 1380° C. for good impregnation and less damage of RBSC, and the thermal treatment time may vary by the size of the bonding surface and the assembly components and preferably, it may be time capable of sufficient melting and bonding, for example, within 30 min to 2 hours.

Further, the present provides a method of preparing the binder, wherein it comprises preparing a mixed powder at least one substance selected from the group consisting of Al, Ti, Fe, Mg, Cu and Ge, and silicon in a mixing ratio in which the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram; and sintering the mixed powder to prepare a sintered binder, or milling the sintered binder to prepare a sintered binder powder, and a detailed description with regard to this is as explained in the above.

Specific examples regarding this are as follows.

Examples for conventional reactive sintering method are as shown in Korean Patent Laid-Open Publication No. 10-2004-111393, and each individual process regarding RBSC is the same as this reactive sintering method in terms of principles. However, the present invention has significance in that in order to improve the problems of the existing manufacturing process as explained in the above for an assembly having complicated structure (e.g., jig) where the assembly has been assembled prior to impregnation process, it developed a binder capable of carrying out assembly after impregnation process in a single part unit, and a binding process.

However, if the order of the processes is simply switched and the assembly is performed using slurry for bonding that has been used in the prior assembly step, a sintering process is required to sinter the bonding slurry. In connection with this, a normal temperature for the sintering of the bonding slurry is 1500 to 2000° C., which are higher than the melting temperature of silicon (approximately 1410° C.)., so that Si elution from the sintered body occurs during the thermal treatment, thereby causing the intensity reduction and shape deformation of the sintered body and thus making it impossible further processing. Hence, the inventors have developed the binder of the present invention and the binding process.

For this, the assembly components, which will constitute RBSC (reaction-bonded silicon carbide) assembly, may be manufactured by the procedures identical to the steps of manufacturing a sintered body in the conventional reactive sintering method.

First, a temporarily-sintered body for the assembly components may be manufactured, and this may include mixing a conventional silicon carbide powder with an organic substance, preferably a solvent (for example, phenol, PVA, PVB, etc.) as a carbon source, drying and then sintering it, and further immersing it into an organic solvent or resin as a carbon source for additional carbon supply. Preferably, the temporarily-sintered body for the assembly components may be manufactured by mixing silicon carbide powder and a carbon source, then molding and temporarily sintering it at 1500 to 2000° C.

Next, the temporarily-sintered body for the assembly components thus obtained may be impregnated into melted silicon. In the prior art, impregnation was conducted with regard to an assembly and accordingly, while an impregnation tub filled with the melted silicon was able to be used to immerse only one assembly, it is now able to immerse at once single parts capable of manufacturing more assemblies if the immersion is performed with regard to single parts, thereby increasing the efficiency of the impregnation tub and the productivity of the process. This impregnation procedure is identical to the impregnation step of the conventional reactive sintering method.

Then, the specimens that complete the impregnation procedure may be processed to be a desired shape for the manufacture of assembly. That is, the sintered body for the assembly components impregnated with silicon is subjected to molding. For example, in the case of a wafer boat, it may include the molding of slots for mounting wafers. If the molding goes wrong in this step, damaged parts can be discarded in a part unit so that it can increase a yield when compared to the prior art in which the whole assembly was subject to be discarded.

Finally, the assembly components that have been molded may be bonded with the binder of the present invention as described in the above. This assembly step may be performed by applying the binder to the bonding surface and conducting thermal treatment at 1300 to 1400° C. to complete the assembly. In this connection, since the existing slurry for bonding is slurry comprising SiC and organic solvents of carbon source, bonding between the parts using this bonding slurry requires thermal treatment of not less than 1500° C. after the bonding slurry is applied, and if this treatment is carried out after Si-impregnation, Si elution from the sintered body occurs. Contrary to this, the invention makes possible bonding between the parts at a temperature lower than the melting point of Si in order to prevent Si elution and further, as the melting point of the binder itself is high, it is applicable to high-temperature process, has less trouble with regard to thermal expansion coefficient after solidification and makes easy impregnation into a sintered body.

Preferably, as shown in the specific embodiment of FIG. 7, this assembly step may be carried out by bonding the assembly components with the bonding slurry (for example, applying it to bind and then drying it in oven), and applying the binder onto the bonding surface bonded with the bonding slurry or the bonding surface with carbon fiber or carbon fiber felt attached thereon because it makes easy to insert the binder into the bonding surface.

The bonding slurry may be conventional bonding slurry used in bonding RBSC and it may include a mixture where silicon carbide powder is mixed with solvents, or a mixture further comprising a carbon source substance including carbon black in addition to the former mixture (for example, SiC:carbon black:phenol=100:1 to 10:1 to 30 (ratio by weight))(in case of FIG. 7, a mixture of SiC powder having # 1000 mesh size+carbon black+phenol (100:1 to 10:1 to 30 (ratio by weight)) was applied and then the binder was attached thereto and after that, the binder was impregnated by thermal treatment and polished to complete bonding process).

In this step, the bonding slurry is not sintered because of low temperature during the bonding procedure, and partially-melted binders are impregnated between the silicon carbide powders and the melted silicon body is reacted with the carbon source and converted into SiC to be bonded to the bonding surface.

With regard to this, on the bonding surface bonded with the bonding slurry, the binder in the form of bulk or powder may be attached onto the bonding slurry so that it can be secured by the bonding slurry, or carbon fiber or carbon fiber felt may be attached onto the bonding slurry constituting the bonding surface and then, the binder in the form of bulk or powder may be attached thereon so that the melted body of the binder can flow into the bonding surface along with the carbon fiber.

In addition, in case that the binder is a slurry type as described in the above, the assembly step may be carried out by applying to the assembly components, which have been processed, the mixture body in the form of slurry (for example, solid solution powder:phenol=30 to 80:1 to 30 (ratio by weight). The mixture body in the form of slurry including the solid solution powder may further comprise silicon carbide powder, carbon source substances, etc. (for example, solid solution powder:SiC powder:carbon black:phenol=30 to 80:100:1 to 10:1 to 30 (ratio by weight)).

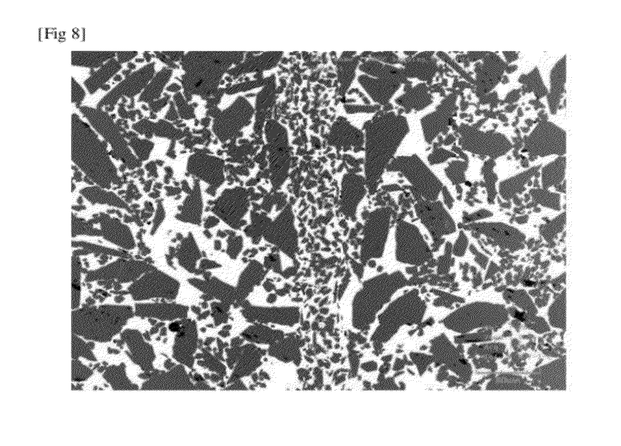

Through the bonding step, RBSC parts can be converted to an assembly. As a specific embodiment, microscopic picture obtained after bonding procedure was carried out as shown in FIG. 7, using a mixture of SiC powder having # 1000 mesh size+carbon black+phenol (100:1 to 10:1 to 30 (ratio by weight) as the bonding slurry, is as shown in FIG. 8. This shows that a binding surface having uninterrupted fine structure has been formed. As a result of three point bending test with regard to the obtained assembly, it showed intensity of about 250 MPa and it was thus verified to have excellent bonding ability.

While FIG. 7 and FIG. 8 illustrate a Si—Ge system, it is to be understood that the same bonding procedures can be applied to other systems.

It is to be understood that the invention as stated in the above is not limited by the aforementioned embodiments and the accompanying drawings, and various modifications and alterations made by those skilled in the pertinent art within the spirit and scope of the invention defined by the following claims are still within the scope of the invention.

What is claimed is:

1. A binder for binding RBSC (reaction-bonded silicon carbide), which is used to prepare RBSC assembly,
wherein it comprises a sintered body obtained by sintering a mixed powder of at least one substance selected from the group consisting of Al, Ti, Fe, Mg, Cu and Ge, and silicon, or a powder obtained by milling the sintered body; and
with regard to the mixing ratio of the mixed powder, the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram.

2. The binder for binding reaction-bonded silicon carbide of claim 1, wherein it is a sintered body obtained by mixing 10 to 50 at % of aluminum powder and 50 to 90 at % of silicon powder, and carrying out first sintering at 800° C.±100° C. and then second sintering at 1000° C.±50° C.

3. The binder for binding reaction-bonded silicon carbide of claim 1, wherein it is a sintered body obtained by mixing 14 to 18 at % of titanium powder and 82 to 86at % of silicon powder, and carrying out first sintering at 1000° C.±50° C. and then second sintering at 1250° C.±50° C.

4. The binder for binding reaction-bonded silicon carbide of claim 1, wherein it is a sintered body obtained by mixing 11 to 19 at % of iron powder and 50 to 90 at % of silicon powder, and carrying out first sintering at 1100° C.±50° C. and then second sintering at 1210° C.±50° C.

5. The binder for binding reaction-bonded silicon carbide of claim 1, wherein it is a sintered body obtained by mixing 8 to 28 at % of magnesium powder and 72 to 92 at % of silicon powder, and carrying out first sintering at 800° C.±100° C. and then second sintering at 1050° C.±50° C.

6. The binder for binding reaction-bonded silicon carbide of claim 1, wherein it is a sintered body obtained by mixing 13 to 36 at % of copper powder and 64 to 87 at % of silicon powder, and carrying out first sintering at 1100° C.±50° C. and then second sintering at 1200° C.±50° C.

7. The binder for binding reaction-bonded silicon carbide of claim 1, wherein it is a sintered body obtained by mixing 5 to 35 at % of germanium powder and 65 to 95 at % of silicon powder, and carrying out single sintering at 1150° C.±50° C.

8. The binder for binding reaction-bonded silicon carbide according to claim 2, wherein the first sintering is carried out for 30 min to 1 hour and the second sintering or the single sintering is carried out for two hours to 4 hours.

9. The binder for binding reaction-bonded silicon carbide according to claim 3, wherein the first sintering is carried out for 30 min to 1 hour and the second sintering or the single sintering is carried out for two hours to 4 hours.

10. The binder for binding reaction-bonded silicon carbide according to claim 4, wherein the first sintering is carried out for 30 min to 1 hour and the second sintering or the single sintering is carried out for two hours to 4 hours.

11. The binder for binding reaction-bonded silicon carbide according to claim 5, wherein the first sintering is carried out for 30 min to 1 hour and the second sintering or the single sintering is carried out for two hours to 4 hours.

12. The binder for binding reaction-bonded silicon carbide according to claim 6, wherein the first sintering is carried out for 30 min to 1 hour and the second sintering or the single sintering is carried out for two hours to 4 hours.

13. The binder for binding reaction-bonded silicon carbide according to claim 7, wherein the first sintering is carried out for 30 min to 1 hour and the second sintering or the single sintering is carried out for two hours to 4 hours.

14. A method of binding RBSC (reaction-bonded silicon carbide) wherein it comprises temporarily bonding RBSC assembly components which will constitute RBSC assembly; and
applying the binder for binding reaction-bonded silicon carbide of claim 1 to the temporarily-bonding surface of the RBSC assembly components and impregnating the binder into the bonding surface by thermal treatment at 1300 to 1400° C. to complete the assembly.

15. The method of binding reaction-bonded silicon carbide of claim 14, wherein the temporary bonding step comprises bonding the RBSC assembly components with slurry for bonding, and applying the binder for binding reaction-bonded silicon carbide of claim 1 onto the bonding surface bonded with the bonding slurry or the bonding surface with carbon fiber or carbon fiber felt attached thereon.

16. The method of binding reaction-bonded silicon carbide of claim 15, wherein the bonding slurry is a mixture where silicon carbide powder is mixed with a solvent, or a mixture further comprising a carbon source substance including carbon black in addition to the former mixture.

17. A method of binding RBSC (reaction-bonded silicon carbide) wherein it comprises adding a solvent to the binder for binding reaction-bonded silicon carbide of claim 1 in the form of powder to prepare a mixture body in the form of slurry; and
binding RBSC assembly components, which will constitute RBSC assembly, with the mixture body in the form of slurry and impregnating the binder into the bonding surface by thermal treatment at 1300 to 1400° C. to complete the assembly.

18. A method of preparing a binder for binding reaction-bonded silicon carbide, wherein it comprises
preparing a mixed powder at least one substance selected from the group consisting of Al, Ti, Fe, Mg, Cu and Ge, and silicon in a mixing ratio in which the maximum amount of silicon is an amount rendering the complete melting temperature of phase in phase diagram of the mixed powder to be at most 1400° C., and the minimum amount of silicon is a larger value of either 50 at % or the minimum amount of silicon in silicon+liquid phase zone of the phase diagram; and
sintering the mixed powder to prepare a sintered binder, or milling the sintered binder to prepare a sintered binder powder.
